(19) United States
(12) Patent Application Publication
(10) Pub. No.: US 2007/0197174 A1
(43) Pub. Date: Aug. 23, 2007

(54) Method and apparatus for reception of mobile broadcast

(75) Inventors: Yong-Deok Kim, Seoul (KR); Young-Hun Joo, Yongin-si (KR); Jeong-Seok Choi, Yongin-si (KR); Kyung-Ho Chae, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/642,263

(22) Filed: Dec. 20, 2006

(30) Foreign Application Priority Data
Feb. 17, 2006 (KR) 2006-15554

(51) Int. Cl. H04B 17/02; H04B 7/08; H04B 1/06

(52) U.S. Cl. 455/140; 455/133; 455/277.1

(57) ABSTRACT

An apparatus for reception of a mobile broadcast is disclosed. The apparatus includes a mobile broadcast reception unit for receiving a broadcast signal transmitted through a mobile broadcasting network, demodulating the broadcast signal into a baseband signal, and outputting the baseband signal; and a wireless Internet broadcast reception unit for receiving a broadcast signal transmitted through a wireless Internet network, demodulating the broadcast signal into a baseband signal, and outputting the baseband signal, and the apparatus also includes a post-processing unit for checking reception sensibilities of the mobile broadcast reception unit and the wireless Internet broadcast reception unit, selecting and decoding one signal of output signals of the mobile broadcast reception unit and the wireless Internet broadcast reception unit according to a result of the checking, and outputting the selected and decoded signal. A reception sensibility of a mobile broadcasting network is monitored while a broadcast is being viewed through the mobile broadcasting network, a pilot signal of a wireless Internet network is measured when a corresponding mobile broadcast has a weak electric field, and a current network is shifted to a corresponding wireless Internet network having a pilot signal with a signal intensity above a threshold value when the corresponding wireless Internet network exists, thereby receiving the broadcast through the corresponding wireless Internet network.

### CLAIM OF PRIORITY

This application claims the benefit under 35 U.S.C. 119(a) of an application entitled “Method And Apparatus For Reception Of Mobile Broadcast” filed in the Korean Intellectual Property Office on Feb. 17, 2006 and assigned Ser. No. 2006-15554, the entire contents of which are incorporated herein by reference.

### BACKGROUND OF THE INVENTION

1. Field of the Invention

The present invention relates to a mobile broadcasting system, and more particularly to a method and an apparatus for successfully receiving mobile broadcasts even in a shadow area.

2. Description of the Related Art

With the rapid spread of portable subscriber stations, such as portable telephones, personal digital assistants (PDA), and portable game machines, a plurality of functions have been integrated into such portable subscriber stations. Two of the most important issues in relation to the functions of the portable subscriber station are mobile broadcasting and a wireless Internet. For this type of mobile broadcasting, terrestrial digital multimedia broadcasting (DMB), satellite DMB, European digital video broadcasting-handheld (DVB-H), and American media forward link only (MediaFLO) compete with each other. Also, for the wireless Internet, wireless broadband (WiBro) and world interoperability for microwave access (WiMAX) are expected to be popularized soon.

In relation to a wired network, many communication/broadcasting fusion services, such as a cable television (TV) business and an Internet Protocol TV (IPTV), and Voice over Internet Protocol (VoIP), have appeared. Similarly, in the case of the portable subscriber stations, a DMB phone and a PDA having a Wireless LAN (WLAN) function have been widely popularized. It is expected that portable subscriber stations having all of these functions combined together will come out in the near future.

Although portable subscriber stations capable of viewing mobile broadcasts have been increasingly popularized, as described above, possessing a portable subscriber station does not always enable the user to view a mobile broadcast regardless of location. For example, when the user enters a shadow area of broadcasting or when reception sensitivity becomes lowered due to adjacent signal interference while the user is viewing a mobile broadcast, such as a terrestrial DMB, a satellite DMB, a DVB-H, a MediaFLO, etc., it often becomes impossible for the user to view the mobile broadcast. In order to prevent such a problem, satellite DMB networks are equipped with a plurality of gap fillers so that satellite DMB signals can be received even in shadow areas, such as buildings and subways. Terrestrial DMB networks also equipped with repeaters within the shadow areas to reduce the problem of the shadow areas.

However, although a great number of repeaters, which requires a considerable cost, are installed in order to remove the shadow areas of mobile broadcasts, as described above, it is impossible to completely remove all shadow areas existing in complicated city layouts and other geographic regions.

### SUMMARY OF THE INVENTION

One aspect of the present invention is to provide a method and an apparatus for reception of a mobile broadcast that enables the user an improved view the mobile broadcast in a shadow area when viewing the mobile broadcast through a portable subscriber station.

One embodiment of the present invention is directed to an apparatus for reception of a mobile broadcast. The apparatus includes a mobile broadcast reception unit for receiving a broadcast signal transmitted through a mobile broadcasting network, demodulating the broadcast signal into a baseband signal, and outputting the baseband signal; and a wireless Internet broadcast reception unit for receiving a broadcast signal transmitted through a wireless Internet network, demodulating the broadcast signal into a baseband signal, and outputting the baseband signal. The apparatus also includes a post-processing unit for checking reception sensibilities of the mobile broadcast reception unit and the wireless Internet broadcast reception unit, selecting and decoding one signal of output signals of the mobile broadcast reception unit and the wireless Internet broadcast reception unit according to a result of the checking, and outputting the selected and decoded signal.

Another embodiment of the present invention is directed to a method for reception of a mobile broadcast. The method includes the steps of monitoring a reception sensibility of a mobile broadcasting network while a broadcast is being viewed through the mobile broadcasting network; measuring a pilot signal of a wireless Internet network when a corresponding mobile broadcast has a weak electric field, as a result of the monitoring of the reception sensibility; and performing a shift operation to a corresponding wireless Internet network having a pilot signal with a signal intensity above a predetermined threshold value. The method also includes the step of receiving the broadcast through the corresponding wireless Internet network, when it is determined as a result of the measuring of the pilot signal that the corresponding wireless Internet network exists.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a view illustrating a mobile broadcasting network to which the present invention may be applied;

FIG. 2 is a view illustrating a wireless Internet network to which the present invention may be applied;

FIG. 3 is a block diagram illustrating a mobile broadcast reception apparatus according to an embodiment of the present invention; and

FIG. 4 is a flowchart illustrating a mobile broadcast reception operation according to another embodiment of the present invention.

### DETAILED DESCRIPTION

Hereinafter, embodiments of the present invention will be described with reference to the accompanying drawings. In the following description, many particular items such as a detailed component device are shown, but these are given only for providing a better understanding of the present invention. Therefore, it will be understood by those skilled in the art that various changes in form and detail may be made within the scope of the present invention.

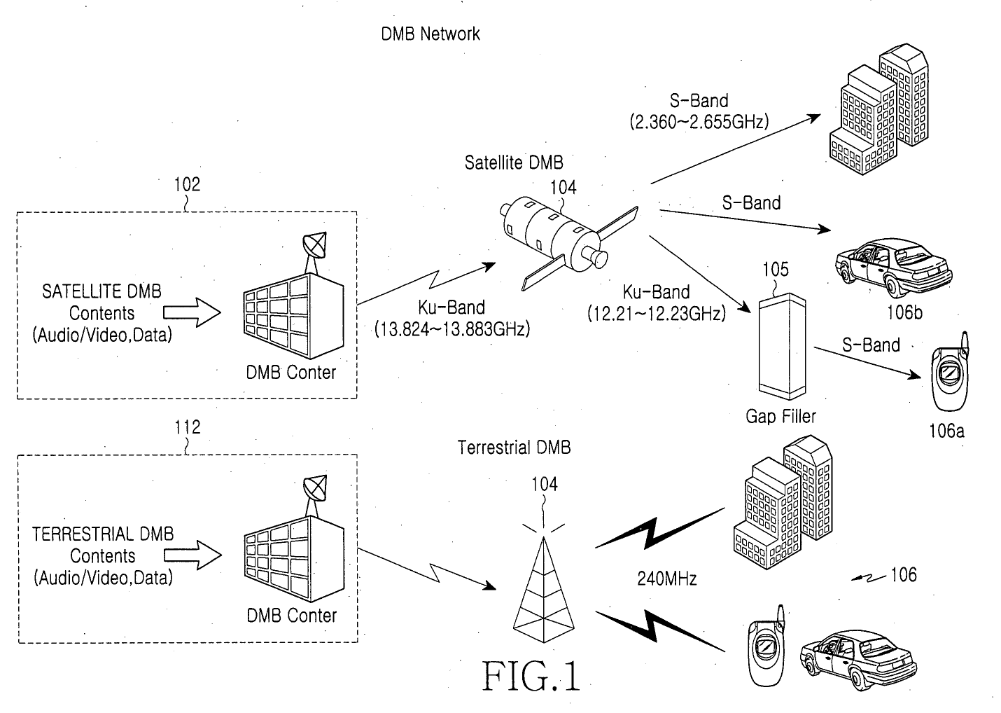

FIG. 1 is a view illustrating a mobile broadcasting network to which the present invention may be applied. First, the construction of the mobile broadcasting network will be described. The mobile broadcasting network includes a satellite DMB network and a terrestrial DMB network as representative networks. In a satellite DMB network, a satellite DMB center 102 converts contents for broadcasting into a broadcast signal. This may be a code division multiplex (CDM) signal or time division multiplex (TDM) signal. This signal is then broadcast to a DMB satellite 104 by using a Ku-band of 13.8 GHz, in order to provide the contents for broadcasting to users. The DMB satellite 104 receives the broadcast signal from the DMB center 102, and transmits the broadcast signal either directly to terrestrial portable subscriber stations (e.g., a mobile terminal 106a for DMB and a terminal 106b installed in a vehicle) through an S-band of 2.6 GHz, or to a gap filler 105 for retransmission to a shadow area through a Ku-band of 12.2 GHz to transmit the broadcast signal to the users 106a and 106b through the gap filler 105.

The terrestrial DMB network includes a terrestrial DMB center 112 that converts contents for broadcasting into a broadcast signal and transmits the broadcast signal through VHF channel Nos. 8 and 12 to provide the contents for broadcasting to users. Also, the terrestrial DMB network includes a broadcast transmission tower 114 or a repeater (not shown) of an individual provider in the case of a shadow area, which transmits a terrestrial broadcast provided by the satellite DMB center 112 to portable subscriber stations 106.

Such a terrestrial DMB network is based on the European digital audio broadcasting (DAB) system.

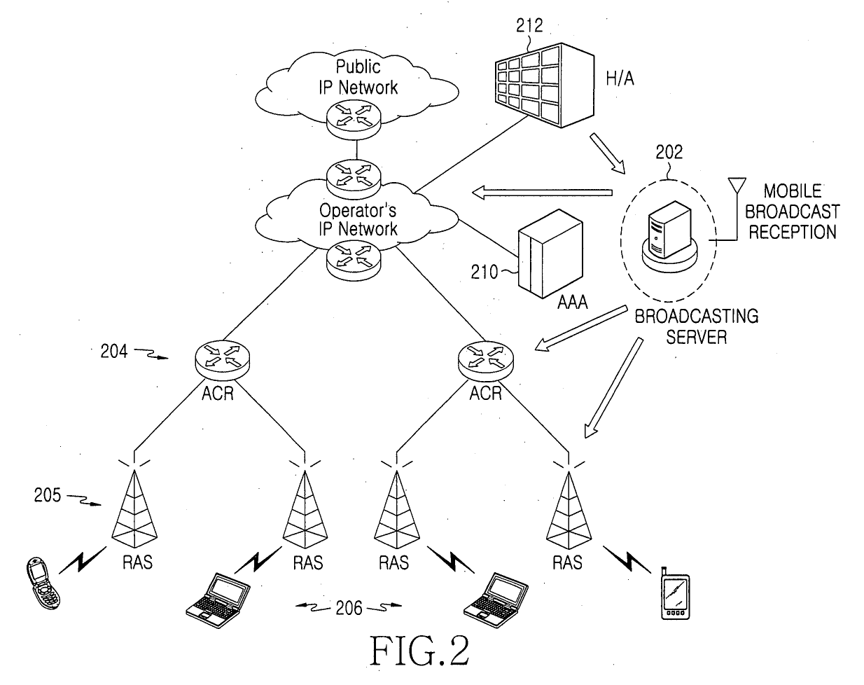

FIG. 2 is a view illustrating a wireless Internet network in which the construction of a wireless broadband (WiBro) network is illustrated as a representative wireless Internet network. First, the construction of a wireless Internet network will be described above. A WiBro network includes a plurality of radio access stations (RASs) 205, and an access control router (ACR) 204 that is connected to a network and controls the RASs 205. Each of the RASs 205 is allocated with a service area, that is, a cell, and provides service to a plurality of portable subscriber stations (PSS) 206 (e.g., a notebook computer and a personal digital assistant (PDA)) located in the cell. Also, a broadcasting server 202 for providing a broadcasting service is included in the upper layer of the ACR 204. In this embodiment, the broadcasting server 202 receives mobile broadcasting contents transmitted as a terrestrial DMB broadcast signal or satellite DMB broadcast signal, encapsulates the mobile broadcasting contents by using an IP, and transmits the encapsulated contents to an IP network so that the mobile broadcasting contents can be provided to the portable subscriber stations 206. Such a broadcasting server 202 may cooperate directly with the IP network, or may be located in the ACR 204 or RAS 205. Otherwise, the broadcasting server 202 may be a multicast and broadcast service (MBS) server for providing an MBS.

In addition, the WiBro network may include a home agent 212 for supporting the IP mobility of a portable subscriber station in a home network, and an AAA (Authentication, Authorization, and Accounting) server 210 for performing the authentication, authorization, and accounting operations with respect to the users and portable subscriber stations to provide network access and service to only authenticated users.

In this embodiment, when the viewing of a mobile broadcast, such as a terrestrial DMB, a satellite DMB, a DVB-H, and a MediaFLO, as shown in FIG. 1, becomes interrupted because the user enters a shadow area of broadcasting or because reception sensitivity becomes lowered due to adjacent signal interference while the user is viewing the mobile broadcast, the user can continuously view the mobile broadcast without interruption by using all wireless Internet networks such as a wireless LAN (WLAN), which are based on 802.16 series WiBro, WiMAX, or Hot Spot, as shown in FIG. 2, which are expected to provide service in a downtown area. To this end, a portable subscriber station determines the intensity of a mobile broadcast signal. Then, when the intensity of a mobile broadcast signal is above a predetermined threshold value, the portable subscriber station is connected to a wireless Internet network to receive the mobile broadcast through the wireless Internet network, by properly using measured values of pilot signals received from cells of wireless Internet networks.

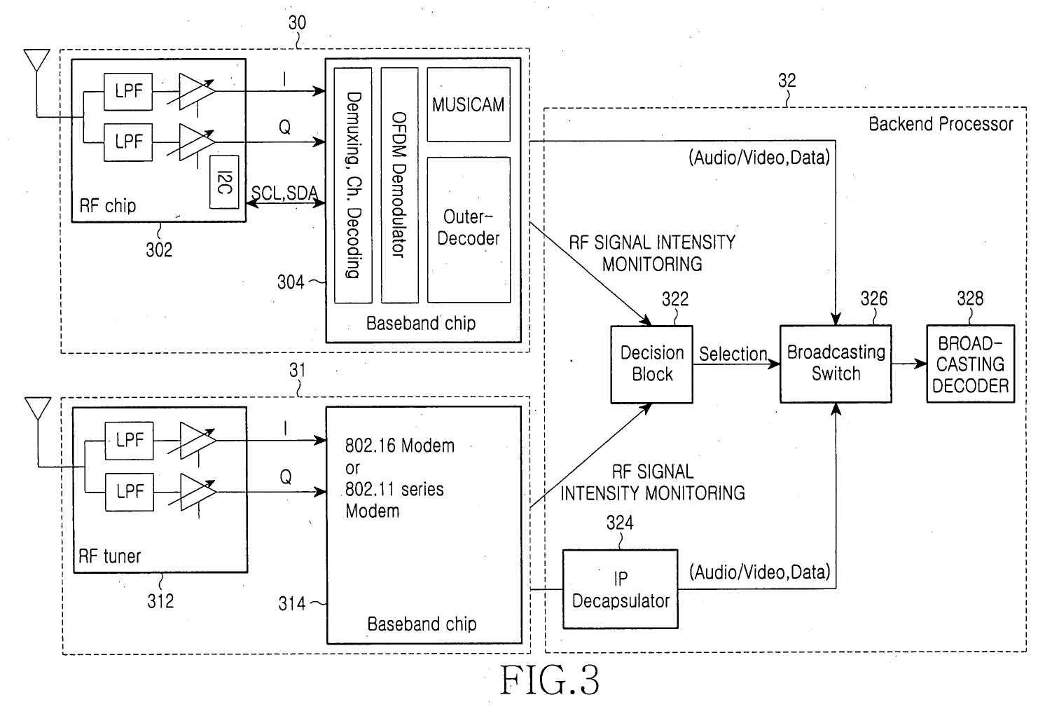

FIG. 3 is a block diagram illustrating a mobile broadcast reception apparatus according to an embodiment of the present invention, in which the mobile broadcast reception apparatus may be employed by a mobile terminal for DMB or a terminal installed in a vehicle. The mobile broadcast reception apparatus includes a mobile broadcast reception unit 30, a wireless Internet broadcast reception unit 31, and a post-processing unit 32. The mobile broadcast reception unit 30 receives a broadcast signal transmitted through a mobile broadcasting network, demodulates the broadcast signal into a baseband signal, and outputs the baseband signal. The wireless Internet broadcast reception unit 31 receives a broadcast signal transmitted through a wireless Internet network, demodulates the broadcast signal into a baseband signal, and outputs the baseband signal. The post-processing unit 32 checks reception sensibilities of the mobile broadcast reception unit 30 and wireless Internet broadcast reception unit 31, selects and decodes one of the output signals of the mobile broadcast reception unit 30 and wireless Internet broadcast reception unit 31 according to the result of the checking, and then outputs the decoded signal.

The mobile broadcast reception unit 30 may include a radio frequency (RF) chip 302 and a baseband chip 304. Using the baseband chip 304, the RF chip 302 receives a mobile broadcast signal input through an antenna and is tuned to receive information of a channel desired by the user. The baseband chip 304 also demodulates a mobile broadcast signal received through the RF chip 302 into a baseband signal.

Similarly, the wireless Internet broadcast reception unit 31 may include a radio frequency (RF) tuner 312 and an 802.16 or 802.11 series wireless Internet modem 314. Using the model 314, the RF tuner 312 receives a wireless Internet broadcast signal input through an antenna and is tuned to receive information of a corresponding channel. The wireless Internet modem 314 also demodulates a wireless Internet broadcast signal received through the RF tuner 312 into a baseband signal.

The post-processing unit 32 includes a decision unit 322, a broadcasting switch 326, and a broadcasting decoder 328. The decision unit 322 checks reception sensibilities of the mobile broadcast reception unit 30 and wireless Internet broadcast reception unit 31, and outputs a selection signal to select one of the outputs of the mobile broadcast reception unit 30 and wireless Internet broadcast reception unit 31 according to a result of the checking. The broadcasting switch 326 selects and outputs one of the outputs of the mobile broadcast reception unit 30 and wireless Internet broadcast reception unit 31 according to the selection signal of the decision unit 322. The broadcasting decoder 328 receives either an output signal of the mobile broadcast reception unit 30 or an output signal of the wireless Internet broadcast reception unit 31, and decodes and outputs the received signal. Also, the post-processing unit 32 may include a decapsulator 324, which performs an IP decapsulation operation with respect to a signal output from the wireless Internet broadcast reception unit 31 and provides the decapsulated signal to the broadcasting switch 326.

The mobile broadcast reception unit 30 illustrated in FIG. 3 has a construction based on terrestrial DMB as an example. A commercial terrestrial DMB chip can measure the intensity of a broadcast signal. In this case, a received signal strength indicator (RSSI) is generally used, and a signal-to-noise ratio (SNR) or bit error rate (BER) may be additionally used to represent the quality of a broadcast signal in order to improve accuracy. In a more detailed description about the example of the terrestrial DMB, the RSSI, which is a value created by a commercial terrestrial DMB chip, represents the weakest electric field when it has a value of −90 dBm and represents the strongest electric field when it has a value of −40 dBm. The SNR represents a ratio of the intensity of an input signal to the intensity of an interference signal, and the BER represents an error rate of an input signal.

The reception sensibility of a mobile broadcast signal can be measured by using these signals, and the measured reception sensibility is input to the decision unit 322 of the post-processing unit 32, as shown in FIG. 3. In this embodiment, the post-processing unit 32 checks reception sensibilities of the mobile broadcast reception unit 30 and wireless Internet broadcast reception unit 31 by using the decision unit 322. The post-processing unit 32 then selects one signal having better quality from among the output signals of the mobile broadcast reception unit 30 and wireless Internet broadcast reception unit 31 according to a result of the checking, and decodes the selected signal.

The operation of the post-processing unit 32 will now be described in more detail with reference to the accompanying drawings.

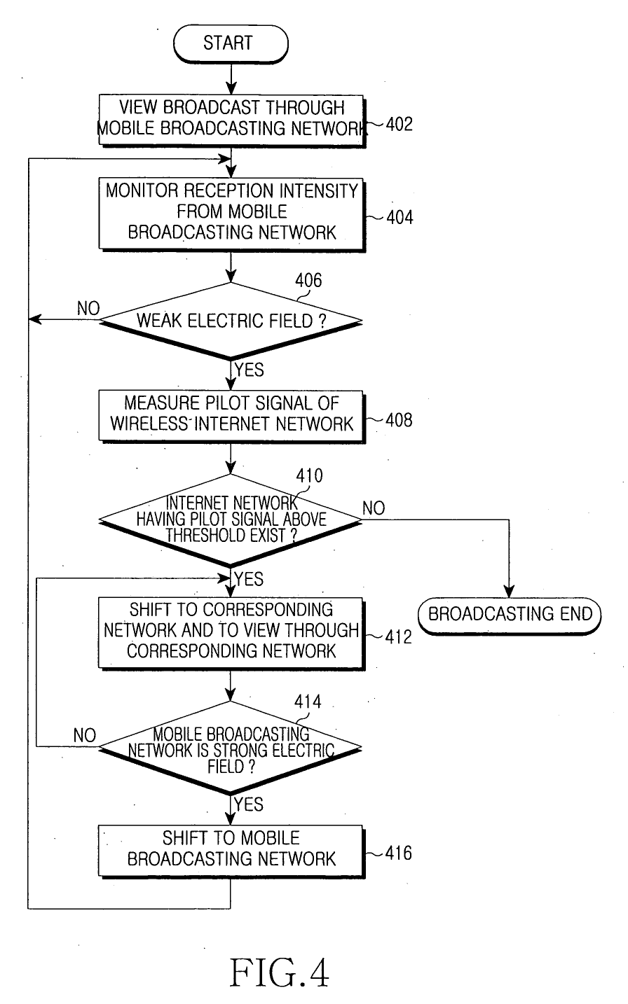

FIG. 4 is a flowchart illustrating a mobile broadcast reception operation according to an embodiment of the present invention. When a broadcast is viewed through a mobile broadcasting network in step 402, a reception intensity from the mobile broadcasting network is monitored in step 404. When a corresponding mobile broadcast has a weak electric field as a result of the reception intensity monitoring, it is sensed in step 406, and then step 408 is performed. In step 408, a pilot signal of a wireless Internet network is measured. In step 410, it is determined if there is a wireless Internet network from which a pilot signal having a signal intensity above a predetermined threshold value is received, based on a result of the measuring of the pilot signal of the wireless Internet network. When it is determined that there is a corresponding wireless Internet network, from which a pilot signal of a signal intensity above the predetermined threshold value is received, step 412 is performed. In step 412, a shift operation is performed to an optimum wireless Internet network from among existing wireless Internet networks, and the broadcast is viewed through the optimum wireless Internet network. When a signal received from the mobile broadcasting network has a strong electric field while the user is viewing the broadcast through the wireless Internet network, it is sensed in step 414 and then step 416 is performed. In step 416, a shift operation is performed to the mobile broadcasting network and then the procedure returns to step 402 so as to repeat the above-mentioned steps.

According to the operation described with reference to FIG. 4, the reception sensibility of a mobile broadcast is continuously monitored while the mobile broadcast is being viewed. A pilot signal of a wireless Internet network is measured when it is determined that a corresponding portable subscriber station is located in a shadow area of mobile broadcasting. When two or more wireless Internet networks (e.g., WLAN, WiBro, etc.) exist, the current network is shifted to a network having a maximum intensity pilot signal above a predetermined threshold value, and mobile broadcast data carried through an IP network are decapsulated and decoded. When the reception sensibility of the mobile broadcast received from the mobile broadcasting network increases to a value above the threshold value, a mode shift is performed to receive the mobile broadcast through the mobile broadcasting network.

With the development of communication technology, broadcasting technology, and embodiment technology for portable subscriber stations, the demands for a portable subscriber station capable of providing all services, which include broadcasting, communication, and Internet service, have been increased. In the current environment, embodiment of present invention provide a portable subscriber station enabling both mobile broadcasting and wireless Internet, and particularly, enables the user to continuously view a broadcast through the wireless Internet even in a shadow area of mobile broadcasting, thereby improving user satisfaction.

While the present invention has been shown and described with reference to a certain embodiments of a mobile broadcast reception method, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. An apparatus comprising:
a first reception unit for receiving a signal transmitted through a mobile communication network, demodulating the signal into a baseband signal, and outputting the baseband signal;
a second reception unit for receiving a signal transmitted through a wireless Internet network, demodulating the signal into a baseband signal, and outputting the baseband signal; and
a processing unit for checking reception sensibilities of the first reception unit and the second reception unit, selecting and decoding one signal of output signals according to a result of the checking, and outputting the selected and decoded signal.

2. The apparatus as claimed in claim 1, wherein the first reception unit comprises:
a radio frequency (RF) unit for receiving a mobile broadcast signal input through an antenna and being tuned to receive information of a channel desired by a user; and
a baseband unit for demodulating a mobile broadcast signal received through the RF chip into a baseband signal.

3. The apparatus as claimed in claim 1, wherein the second reception unit comprises:
a radio frequency (RF) tuner for receiving a wireless Internet broadcast signal input through an antenna and being tuned to receive information of a corresponding channel; and
a wireless Internet modem for demodulating a wireless Internet broadcast signal received through the RF tuner into a baseband signal.

4. The apparatus as claimed in claim 1, wherein the processing unit comprises:
a decision unit for checking reception sensibilities of the first reception unit and the second reception unit, and outputting a selection signal to select one of output signals according to a result of the checking;
a switch for selecting and outputting one of the output signals according to the selection signal of the decision unit; and
a decoder for receiving either the output signal of the output signals, and decoding and outputting the received signal.

5. The apparatus as claimed in claim 2, wherein the processing unit comprises:
a decision unit for checking reception sensibilities of the first reception unit and the second reception unit, and outputting a selection signal to select one of output signals according to a result of the checking;
a switch for selecting and outputting one of the output signals according to the selection signal of the decision unit; and
a decoder for receiving either the output signal of the output signals, and decoding and outputting the received signal.

6. The apparatus as claimed in claim 3, wherein the processing unit comprises:
a decision unit for checking reception sensibilities of the first reception unit and the second reception unit, and outputting a selection signal to select one of output signals according to a result of the checking;
a switch for selecting and outputting one of the output signals according to the selection signal of the decision unit; and
a decoder for receiving either the output signal of the output signals, and decoding and outputting the received signal.

7. A method for reception of a mobile broadcast, the method comprising the steps of:
monitoring a reception sensibility of a mobile broadcasting network while a broadcast is being viewed through the mobile broadcasting network;
measuring a pilot signal of a wireless Internet network when a corresponding mobile broadcast has an electric field below a first predetermined level, as a result of the monitoring of the reception sensibility; and
performing a shift operation to a corresponding wireless Internet network having a pilot signal with a signal intensity above a predetermined threshold value, and receiving the broadcast through the corresponding wireless Internet network, when it is determined as a result of the measuring of the pilot signal that the corresponding wireless Internet network exists.

8. The method as claimed in claim 7, wherein, when a signal from the mobile broadcasting network has an electric field above a second predetermined level, while the broadcast is being viewed through the corresponding wireless Internet network into which the shift operation has been performed, a shift operation is performed to the mobile broadcasting network so as to view the broadcast through the mobile broadcasting network.

9. The method as claimed in claim 7, wherein, when there are at least two wireless Internet networks having a pilot signal above a second predetermined threshold value, as a result of the measuring of the pilot signal, the shifting operation is performed to one of the wireless Internet networks from which a maximum pilot signal is received.

10. The method as claimed in claim 8, wherein, when there are at least two wireless Internet networks having a pilot signal above the second predetermined threshold value, as a result of the measuring of the pilot signal, the shifting operation is performed to one of the wireless Internet networks from which a maximum pilot signal is received.
